(19) United States
(12) Patent Application Publication
(10) Pub. No.: US 2018/0300661 A1
(43) Pub. Date: Oct. 18, 2018

(54) SYSTEMS AND METHODS FOR RESOURCE-LEVEL COST RECOVERY AND EXPENSE ALLOCATION BASED ON BUDGET, FORECAST, AND ACTUALS

(71) Applicant: JPMorgan Chase Bank, N.A., New York, NY (US)

(72) Inventors: Keith A. Zimmerer, Westerville, OH (US); George Robertson, West Chester, PA (US); Lyn Hublein, Hockessin, DE (US)

(21) Appl. No.: 15/952,404

(22) Filed: Apr. 13, 2018

Related U.S. Application Data
(60) Provisional application No. 62/485,138, filed on Apr. 13, 2017.
(60) Provisional application No. 62/485,140, filed on Apr. 13, 2017.

(51) Int. Cl. G06Q 10/06; G06Q 20/14

(52) U.S. Cl. CPC G06Q 10/06312; G06Q 10/06313; G06Q 20/14

(57) ABSTRACT

System and methods for resource-level cost recovery and expense allocation based on budget, forecast, and actuals are disclosed. According to one embodiment, in an information processing device comprising at least one computer processor, a method for cost recovery and expense allocation may include: (1) receiving billing key information and project associations for an organization; (2) associating the billing key information with the project associations; (3) determining a cost plan for the organization; (4) receiving an expense entry; (5) receiving at least one recovery rule; and (6) determining an allocation and recovery for the expense.

### RELATED APPLICATIONS

This application claims priority to U.S. Provisional Patent Application Ser. No. 62/485,138, filed Apr. 13, 2017 and U.S. Provisional Patent Application Ser. No. 62/485,140, filed Apr. 13, 2017. The disclosures of each of these documents is hereby incorporated, by reference, in its entirety.

### BACKGROUND OF THE INVENTION

### 1. Field of the Invention

The present disclosure generally relates to systems and methods for resource-level cost recovery and expense allocation based on budget, forecast, and actuals.

### 2. Description of the Related Art

Project and Portfolio Management (PPM) financial modules, such as CA's PPM (formerly CA Clarity PPM) financial module, often recover labor and non-labor expenses at a project level. Chargebacks—the allocation of expenses to an organization's internal clients, such as business units—are only performed backward-looking against actual expenses at the project level. Generally, there is no support for forward-looking allocations based on annual budget (plan), monthly forecast, and actuals.

### SUMMARY OF THE INVENTION

System and methods for resource-level cost recovery and expense allocation based on budget, forecast, and actuals are disclosed. According to one embodiment, in an information processing device comprising at least one computer processor, a method for cost recovery and expense allocation may include: (1) receiving billing key information and project associations for an organization; (2) associating the billing key information with the project associations; (3) determining a cost plan for the organization; (4) receiving an expense entry; (5) receiving at least one recovery rule; and (6) determining an allocation and recovery for the expense.

In one embodiment, the billing key information may include at least one of an owner, a rule effective data range, a legal entity, a company, a charge number, and a percent allocation.

In one embodiment, the project association may include at least one of a project identifier for the billing key, a work flow, and a cross-reference.

In one embodiment, the cost plan may be calculated by applying a resource rate to a resource quantity for a period of time.

In one embodiment, the resource quantity may be based on hours.

In one embodiment, the resource quantity may be based on a unit of work.

In one embodiment, the period of time may be an hour, a day, a week, a quarter, a year, etc.

In one embodiment, the expense data may be received automatically from at least one of a time entry, a transaction entry, and a bulk upload of expenses.

In one embodiment, the bulk upload of expenses may include a plan year, a source, a type of expense, an entity associated with the cost, and an amount.

In one embodiment, the recovery rule may identify a business unit for cost recovery.

In one embodiment, a batch script may determine the allocation and recovery for the expense.

In one embodiment, the allocation and recovery may be calculated for a future time period.

In one embodiment, the allocation may be sourced from at least one of a cost plan of record, a budget plan of record, and a work in progress report.

In one embodiment, the cost recovery may be calculated by multiplying a number or resource units by a resource rate, and the allocation may be calculated by multiplying the cost recovery by a percentage for the business unit.

In one embodiment, the method may further include presenting the allocation and recovery in a user interface.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for resource-level cost recovery and expense allocation based on budget, forecast, and actuals according to one embodiment;

FIG. 2 depicts a method for resource-level cost recovery and expense allocation based on budget, forecast, and actuals according to one embodiment; and

FIG. 3 depicts a method for extracting, processing, and reporting of allocation and recovery data from an integrated PPM solution according to one embodiment.

### DETAILED DESCRIPTION OF PREFERRED EMBODIMENTS

Systems and methods for resource-level cost recovery and expense allocation based on budget, forecast, and actuals are disclosed.

In embodiments, an allocation engine may provide custom objects to PPM financial modules, and an engine to perform the requisite calculations and store the resulting data for reporting.

Embodiments may provide improved visibility to expense recovery based on, for example, an organizational hierarchy, for individual resources. In addition, embodiments provide for the allocation of expenses for plan, forecast, and actuals. Embodiments may further provide a billing key library for allocating expenses.

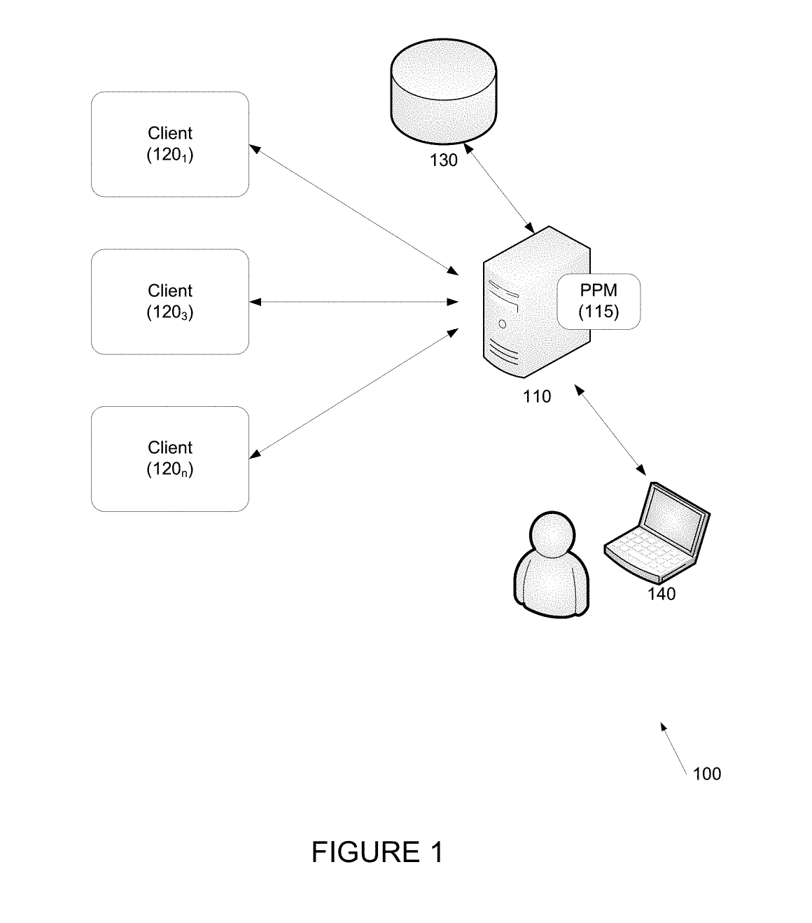

Referring to FIG. 1, a system for resource-level cost recovery and expense allocation is provided according to one embodiment. FIG. 1 includes server 110 and clients 120₁, 120₂, 120ₙ. In one embodiment, clients 120₁, 120₂, 120ₙ may be within the same organization; in another unit, some of clients 120₁, 120₂, 120ₙ may be external to an organization.

Server 110 may include one or more computer processors and may execute a computer program or application. In one embodiment, server 110 may execute one or more Project and Portfolio Management modules (PPM) 115, such as CA's PPM.

In one embodiment, PPM 115 may receive, from one or more client 120, data including, for example, the client's application portfolio (e.g., applications, including plans to build, operate, invest in, maintain, divest, etc.), a financial hierarchy (e.g., lines of businesses, cost centers, etc.), labor resource data (e.g., lines of business, cost centers, employees, contractors, roles, locations, etc.), labor rates, billing keys (e.g., cost centers, allocation percentages, etc.), program/project portfolios and statuses (e.g., investment classes, application mapping, milestones, statuses, risks/issues, reporting tags, etc.), resource allocation and financial plans (e.g., named and generic resources, non-labor expenses, cost plans and budget plans, etc.), and time entry and actual expenses (e.g., application-level time entry, other expenses, etc.).

Clients 120₁, 120₂, 120ₙ may be business units, subsidiaries, affiliates, etc. In one embodiment, each client may have automated reporting tools (not shown) that may provide one or more of billing keys, cost plan and/or budgeting, expense entry, recovery rules, etc. In one embodiment, the reporting features may include, for example, machine-learning capabilities.

One or more database 130 that may maintain data related to budgets, charges, etc. for one or more of clients 120₁, 120₂, 120ₙ may be provided. In one embodiment, database(s) 130 may maintain the data received from automated reporting tools for clients 120.

User interface 140 may be provided and may interface with server 110. User interface 140 may be any suitable electronic device, including, for example, smartphones, tablet computers, desktop computers, laptop/notebook computers, Internet of Things (IoT) appliances, etc.

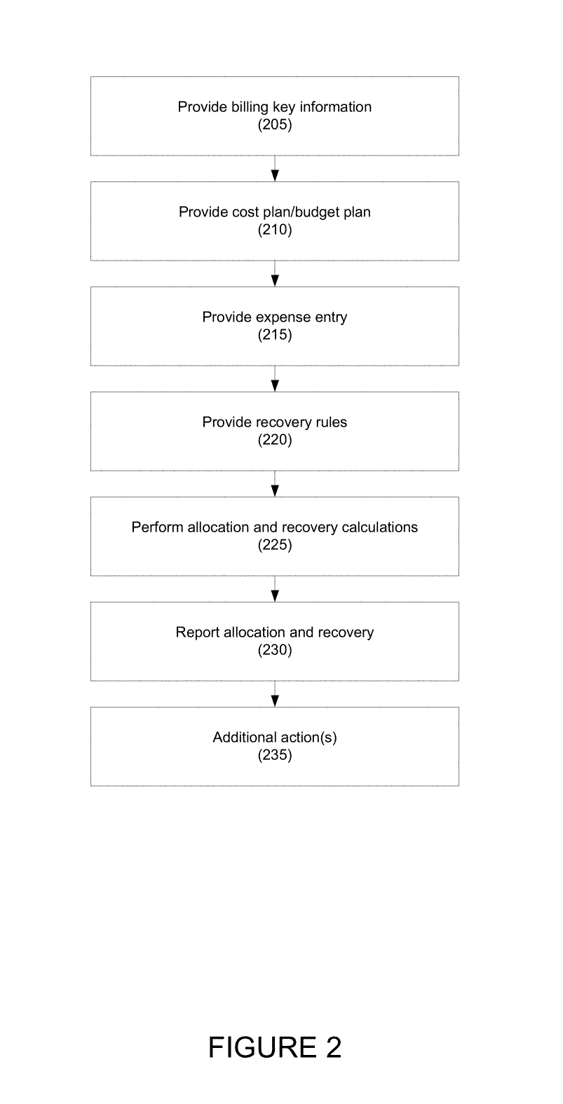

Referring to FIG. 2, a method for resource-level cost recovery and expense allocation is provided according to one embodiment.

In step 205, billing key information and/or project associations may be provided to a computer program. In one embodiment, billing key information may include, for example, an owner, a rule effective data range, a legal entity, a company, a charge number, a percent allocation, etc. Project associations may include, for example, Project IDs that may apply billing key, workflow, populate billing key on Project object (e.g., Financial Summary Page) for cross reference purposes, etc. In one embodiment, maintenance for billing keys may be through a user interface, bulk upload, etc.

In step 210, a cost and/or budgeting plan may be provided to a computer program. In one embodiment, the cost and/or budgeting may be calculated by applying rates against resource quantities (e.g., labor hours, units of work, or simple quantity) at a point in time, or spread over a period of time (e.g. hourly, daily, weekly, quarterly, annually).

In step 215, expense data may be provided to a computer program. For example, expense data may be received automatically, from, for example, time entry, transaction entry, bulk upload of expenses, etc. In one embodiment, the bulk upload may contain, for example, plan year, source (e.g., Budget, Forecast or Actual), the type (e.g., Allocation or Recovery), the entity, the cost center, the fiscal period, the amount, and/or any information as is necessary and/or desired.

In step 220, recovery rules may be provided to a computer program to identify the cost center for cost recovery. In one embodiment, recovery rules may include, for example, business rules that may specify the Cost Center to use for recovery. For example, for an expense type of Labor, the entity's resource cost center may be used; for an expense type of expense, the entity's project cost center may be used.

In one embodiment a batch script may be used to calculate allocation/recovery for a current or forward fiscal period. In one embodiment, the batch script may not recalculate for past periods. Allocations may be sourced, for example, from a cost plan of record (for forecast), from a budget plan of record (for budget), and/or from work in progress for actuals.

In step 225, allocation and recovery calculations may be performed. In one embodiment, the allocation and recovery calculation may be calculated as follows:

Cost recovery=Resource Units*Resource Rate applied 100% to the resource cost center;

Allocation=(Resource Units*Resource Rate)*Allocation Percentageₙ applied to Cost Center n, where n varies from 1 to the number of cost centers in a billing key.

In step 230, the allocation and recovery calculations may be reported. In one embodiment, the allocation and recovery calculations may be reported to the user via a user interface.

In step 235, other actions may be taken. For example, in one embodiment, the allocations may be used to project allocations for a future budget for a client. This may lead to increasing or decreasing allocations for future periods.

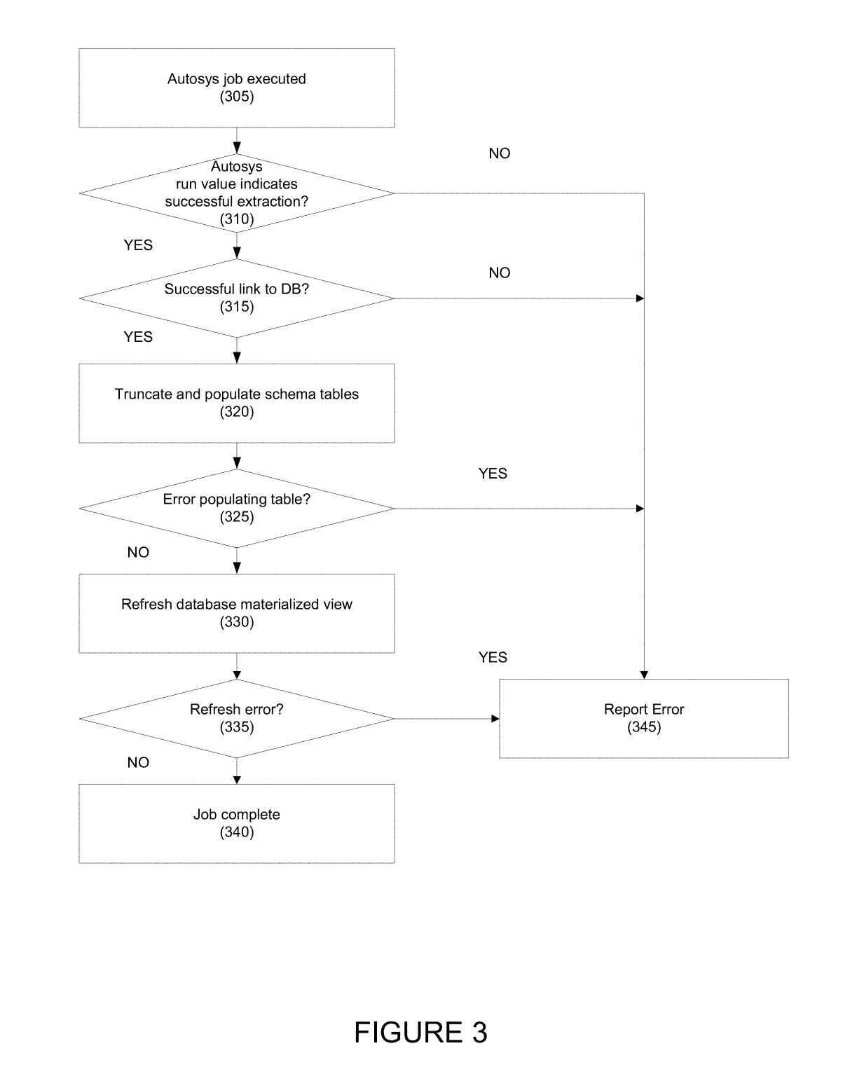

Referring to FIG. 3, a method for extracting, processing, and reporting of allocation and recovery data from an integrated PPM solution is disclosed according to one embodiment.

In step 305, an autosys job may be executed. In one embodiment, the autosys job may call a process to extract project identification data, associated billing key, and all resource units and associated cost by period.

In step 310, a check is made to see if the autosys run value indicates a successful extraction of the data. If it is not, in step 345, an error may be reported.

If the run value indicates success, in step 315, a check is made to see if there is a successful link to a database. If it is not, in step 345, an error may be reported.

In the database is linked, in step 320, schema tables may be truncated and populated.

In step 325, a check is made to see if there was an error populating data. If there is, in step 345, an error may be reported.

If there is not an error, in step 330, a refresh of the database materialized view (MV) may be performed.

In step 335, a check is made to see if there was a refresh error updating the materialized view from step 330. If there was, in step 345, an error may be reported.

If there is not, in step 340, the job may be complete.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for cost recovery and expense allocation comprising:
in an information processing device comprising at least one computer processor:
receiving billing key information and project associations for an organization;
associating the billing key information with the project associations;
determining a cost plan for the organization;
receiving an expense entry;
receiving at least one recovery rule; and
determining an allocation and recovery for the expense.

2. The method of claim 1, wherein the billing key information comprises at least one of an owner, a rule effective data range, a legal entity, a company, a charge number, and a percent allocation.

3. The method of claim 1, wherein the project association comprises at least one of a project identifier for the billing key, a work flow, and a cross-reference.

4. The method of claim 1, wherein the cost plan is calculated by applying a resource rate to a resource quantity for a period of time.

5. The method of claim 4, wherein the resource quantity is based on hours.

6. The method of claim 4, wherein the resource quantity is based on a unit of work.

7. The method of claim 4, wherein the period of time is one of an hour, a day, a week, a quarter, and a year.

8. The method of claim 1, wherein the expense data is received automatically from at least one of a time entry, a transaction entry, and a bulk upload of expenses.

9. The method of claim 8, wherein the bulk upload of expenses comprises a plan year, a source, a type of expense, an entity associated with the cost, and an amount.

10. The method of claim 1, wherein the recovery rule identifies a business unit for cost recovery.

11. The method of claim 1, wherein a batch script determines the allocation and recovery for the expense.

12. The method of claim 1, wherein the allocation and recovery are calculated for a future time period.

13. The method of claim 1, wherein the allocation is sourced from at least one of a cost plan of record, a budget plan of record, and a work in progress report.

14. The method of claim 1, wherein the cost recovery is calculated by multiplying a number or resource units by a resource rate; and
the allocation is calculated by multiplying the cost recovery by a percentage for the business unit.

15. The method of claim 1, further comprising:
presenting the allocation and recovery in a user interface.
